(19) United States
(12) Patent Application Publication
(10) Pub. No.: US 2004/0065495 A1
(43) Pub. Date: Apr. 8, 2004

(54) Drive mechanism of an electrical bike

(76) Inventor: Peng-Yu Huang, Pan-Chiao City (TW)

Correspondence Address: TROXELL LAW OFFICE PLLC, SUITE 1404, 5205 LEESBURG PIKE, FALLS CHURCH, VA, 22041, US

(21) Appl. No.: 10/261,940

(22) Filed: Oct. 2, 2002

(51) Int. Cl. B62M 23/02

(52) U.S. Cl. 180/220; 180/205

(57) ABSTRACT

The present invention relates to a drive mechanism of an electrical bike which has a drive motor positioned at outer side of the front fork thereof. A power output shaft of the drive motor vertically extends from a gearbox and directly coupled with axle of the front wheel through a gear. The drive motor drives the front wheel into rotation so as to achieve the effect of an auxiliary or a full drive for the bike. Besides, the drive motor and related components are well distributed to the front wheel so that the loading of the rear wheel can be effectively reduced, thereby improving the control performance in riding.

### BACKGROUND OF THE INVENTION

1. Field of the Invention

The present invention relates to a drive mechanism of an electrical bike, and more particularly, to drive mechanism mounted to the front fork of bicycles to directly drive the front wheel thereof for locomotion.

2. Description of the Prior Art

With the development of the environment protection in worldwide modern countries, the electrical transportation means have been more and more valued. Since the structure of the electrical bike is more simple and the promotion cost is lower, it can be regarded as one of the more successful electrical transportation means.

A conventional electrical bike, disclosed in TW Pat. No. 470036, describes that a drive motor is installed at the rear wheel while the power control unit of the drive motor is placed at the lower part of rear fork of the bike frame. The action of the pedal will be detected by the power control unit. And the motor can be driven by a pull rope disposed at the handle bar, thereby saving the labor of the cyclist.

Another conventional electrical bikes, disclosed in TW Pat. No. 467091 and 404383 describe a disk-like housing for the wheel hub on the axle of the rear wheel. Within the disk-like housing is included an electric motor in cooperation with a flywheel to join a manual drive portion. Therefore, the rear wheel can be electrically or/and manually driven for locomotion.

Moreover, a further electrical bike, disclosed in TW Pat. No. 371937 describes a gear lever and a power switch mounted on the handle bar. A brake is mounted on the front tube of the main frame. A battery set is interposed between the upper and the lower traverse tubes. Besides, an electromagnetic reduction servomotor unit is installed at the rear side behind the seat. The main drive shaft of the reduction motor is joined with a plurality of unidirectional sprockets in connection with a wheel chain. Accordingly, the rear wheel of the bike can be driven by the wheel chain.

The main power source of the above-mentioned is installed at the center or at the rear end of the main frame of the bike. Therefore, the rear wheel of the bike is directly or indirectly driven through a transmission unit. Most of the conventional electrical bikes are rear wheel drive so that the structure of the rear axle having motor and control elements in addition to chain, toothed wheels, brake and derailleur elements becomes more and more complicated, thereby increasing difficulty of the whole development and the production cost. Moreover, the repair of the bike becomes more difficult. Furthermore, the increased weight is loaded only to the rear wheel, thereby resulting in a great deal of wear and tear and affecting the control effect.

### SUMMARY OF THE INVENTION

It is a primary object of the present invention to eliminate the aforementioned drawbacks and to provide a drive mechanism of an electrical bike which has a drive motor positioned at outer side of the front fork thereof. A power output shaft of the drive motor vertically extends from a gearbox and directly coupled with axle of the front wheel through a gear. The drive motor drives the front wheel into rotation so as to achieve the effect of an auxiliary or a full drive for the bike. Besides, the drive motor and related components are well distributed to the front wheel so that the loading of the rear wheel can be effectively reduced, thereby improving the control performance in riding.

It is another object of the present invention to provide a drive mechanism of an electrical bike wherein a change-speed hub mechanism is arranged within the front wheel hub. The gear ration of the power transmission can be duly adjusted to produce different speed and torsion as required.

### BRIEF DESCRIPTION OF THE DRAWINGS

The accomplishment of this and other objects of the invention will become apparent from the following description and its accompanying drawings of which:

FIG. 1 is a perspective assembly view of a first embodiment of the present invention;

FIG. 2 is an exploded view of the first embodiment of the present invention;

FIG. 3 is a schematic drawing of the first embodiment of the present invention before connection with drive unit;

FIG. 4 is a schematic drawing of the first embodiment of the present invention after connection with drive unit;

FIG. 5 is a perspective assembly view of a second embodiment of the present invention;

FIG. 6 is an exploded view of the second embodiment of the present invention;

FIG. 7 is a schematic drawing of the second embodiment of the present invention before connection with drive unit; and

FIG. 8 is a schematic drawing of the second embodiment of the present invention after connection with drive unit.

### DETAILED DESCRIPTION OF THE PREFERRED EMBODIMENT

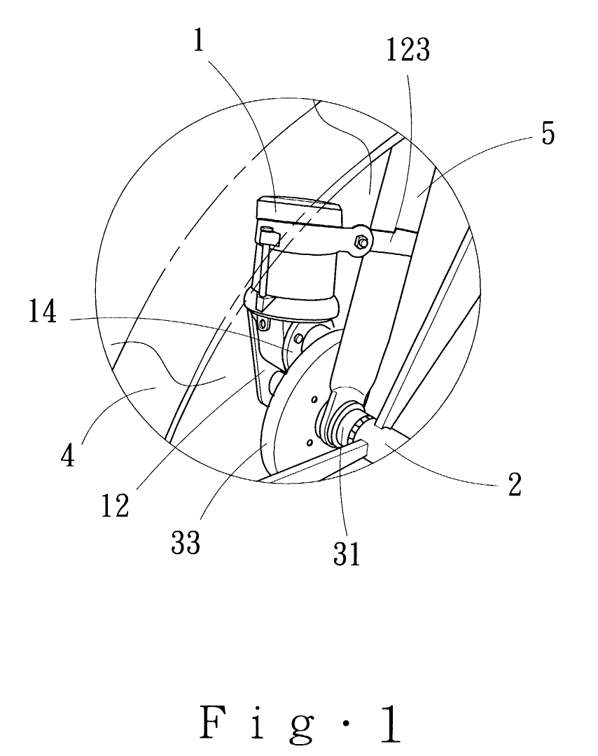

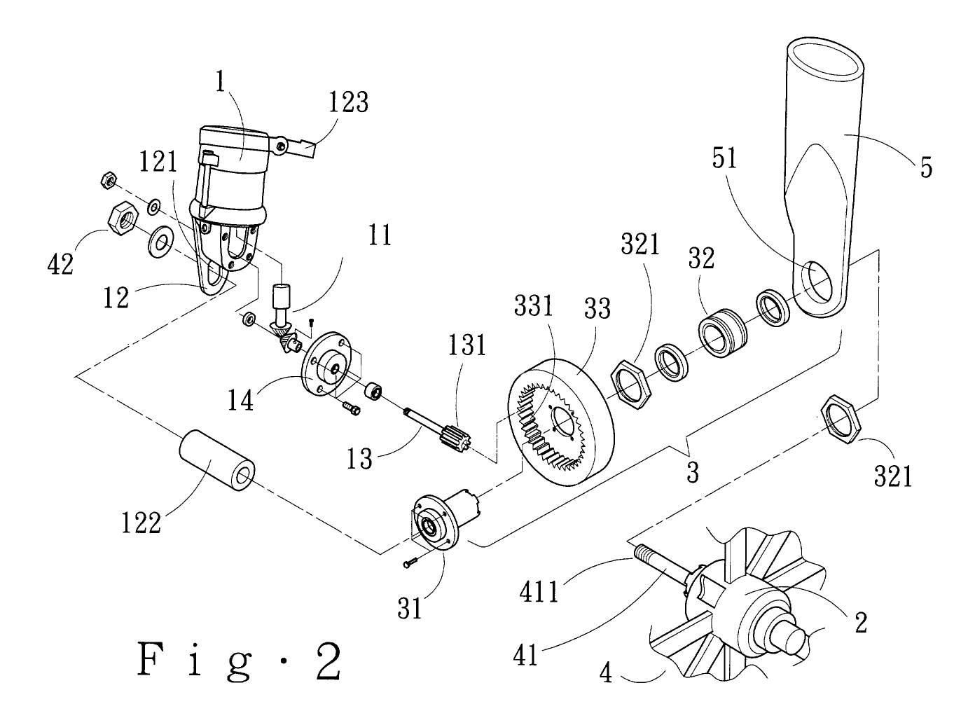

FIG. 1 and FIG. 2 show an assembly and an exploded view of the first embodiment of the present invention. It's apparent from FIG. 2 that the present invention primarily includes a drive motor 1, a change-speed hub 2 and a transmission unit 3. The drive motor 1 makes use of a transmission gear set 11 such that the power output shaft 13 and the central axis of the drive motor 1 vertically extend. The outer end of the power output shaft 13 is provided with a toothed wheel 131. The top end of the drive motor 1 is fixed to the front fork 5 of the bike by means of a mounting bar 123. The drive motor 1 has an extension bar 12 with an elongated hole 121 extending at bottom end thereof. The change-speed hub 2 is arranged at outer side of the axle 41 of the front wheel 4. A change-speed gear is fitted within the change-speed hub 2. The gear ratio of the change-speed hub 2 is changeable by a pull rope. The transmission unit 3 includes an internal bearing block 31, a side bearing block 32 and an internal gear disk 33. The internal bearing block 31 and the side bearing block 32 are mounted around the axle 41, and they are pivotable on the corresponding bearings. Besides, the side bearing block 32 extends into a through hole 51 of the front fork 5 and is secured by two fixing nuts 321. The internal bearing block 31 is joined with the internal gear disk 33 to create a coupling rotation. Besides, the internal bearing block 31 is formed as an internal ring gear having a plurality of internal ring teeth 331.

In assembly, a socket 122 is inserted around the axle 41 of the front wheel 4. Thereafter, the axle 41 extends through the elongated hole 121 of the extension bar 12 and is fixed by means that a positioning nut 42 is screwed to male thread 411 around the end of the axle 41. Meanwhile, the axle 41 is connected to the power output shaft 13 of the drive motor 1. Additionally, the toothed wheel 131 extends into the internal gear disk 33 meshed with the internal ring teeth 331. Furthermore, the internal gear disk 33 is coupled with the change-speed hub 2 by means of the side bearing block 32.

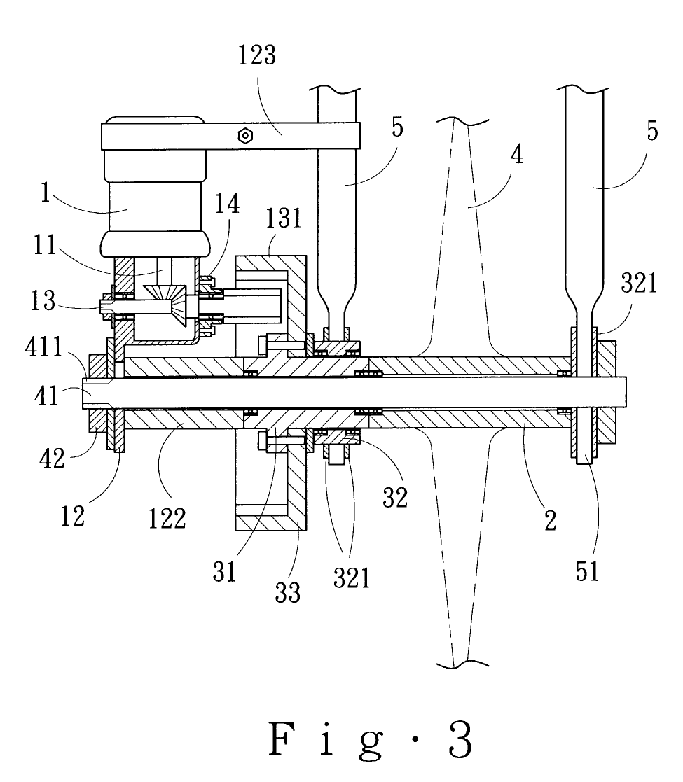

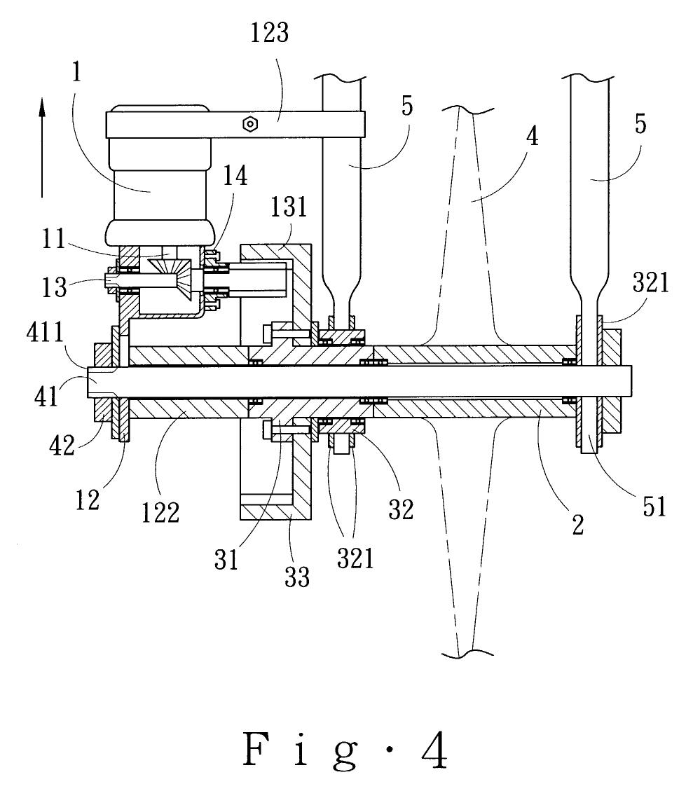

FIG. 3 and 4 show a schematic drawing of the first embodiment of the present invention before and after connection with drive unit. It's apparent from these two figures that the drive motor I descends (while the axle 41 ascends along the elongated hole 121) when the cyclist is in good physical condition or others (downhill or high speed). At this time, the toothed wheel 131 is not meshed with the internal ring teeth 331 of the internal gear disk 33 so that the power of the drive motor 1 doesn't transmitted to the internal gear disk 33 coupled with the change-speed hub 2. Therefore, the front wheel 4 naturally runs only with the external force. When the bike goes uphill or need to be accelerated, the drive motor I can be switched on to ascend the drive motor 1 (while the axle 41 descends along the elongated hole 121). At this time, the toothed wheel 131 of the power output shaft 13 is meshed with the internal ring teeth 331 of the internal gear disk 33. Therefore, the output power of the drive motor 1 can be directly transmitted to the internal gear disk 33 to drive the internal gear disk 33 (change-speed hub 2). Accordingly, the front wheel 4 can be brought into rotation. Moreover, the cyclist can adjust the ratio of gear within the change-speed hub 2 by means of change-speed mechanism in accordance with the speed of bike, the required torsion (uphill), etc. So, the front wheel 4 produces a proper rotational speed according to the treading speed of the cyclist, thereby achieving the effect of an auxiliary or a full drive.

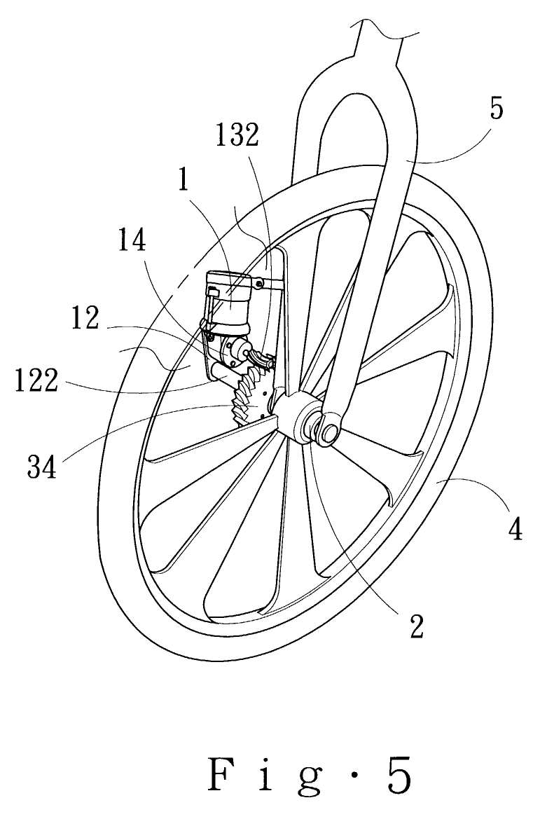

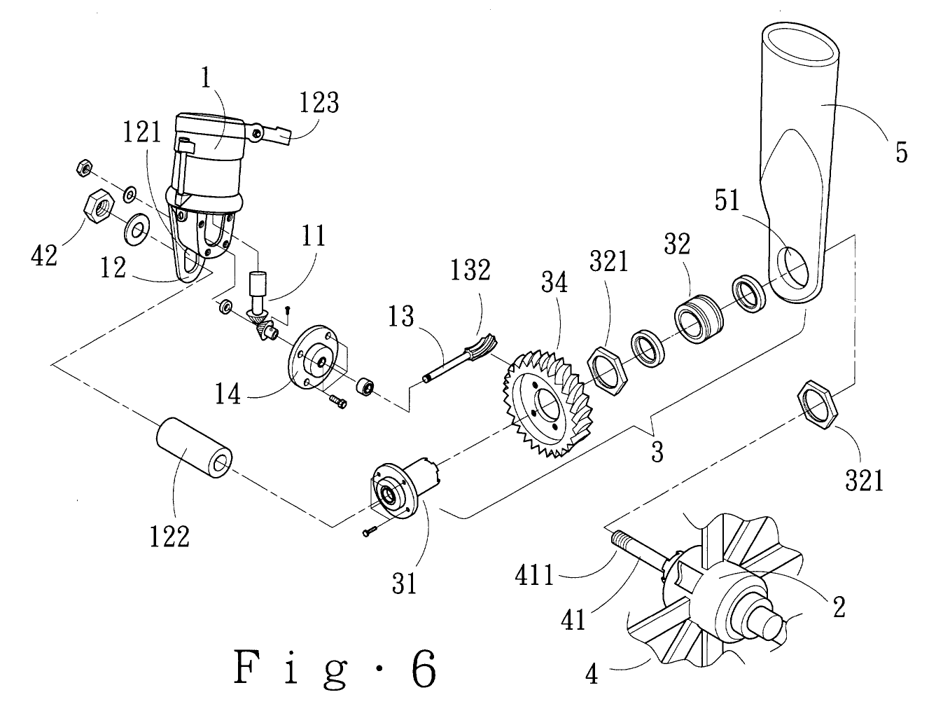

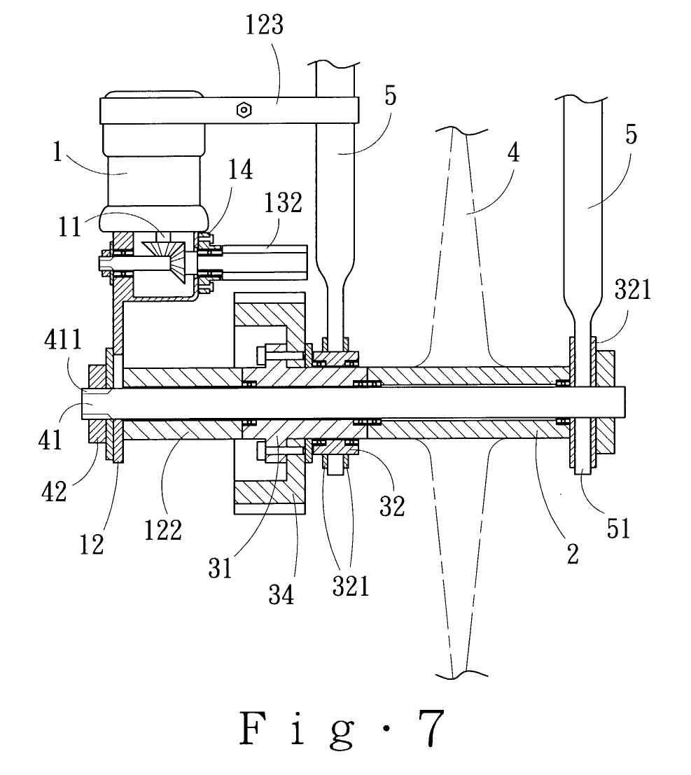

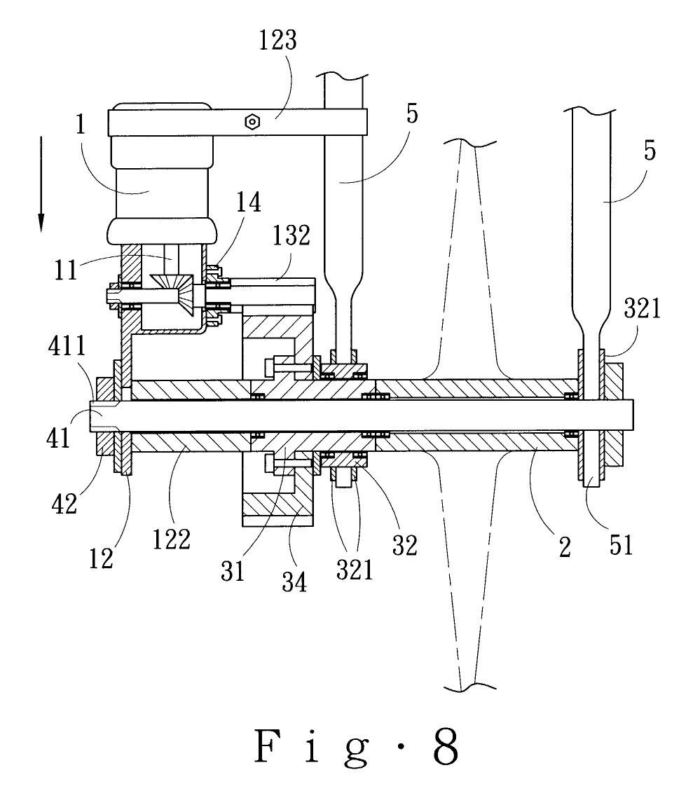

FIG. 5 and FIG. 6 show an assembly and an exploded view of a first embodiment of the present invention. FIG. 7 and 8 show a schematic drawing of the second embodiment of the present invention before and after connection with drive unit. It's apparent from these four figures that the internal bearing block 31 is directly connected with a bevel gear 34. The power output shaft 13 includes another bevel gear 132 at the end of the power output shaft 13. Otherwise, this embodiment has the same components as the first embodiment has. In use, when the auxiliary power of the drive motor 1 is required, the drive motor 1 can be switched on to lower the drive motor 1 (while the axle 41 ascends along the elongated hole 121). At this time, the bevel gear 132 of the power output shaft 13 is meshed with the bevel gear 34. Therefore, the output power of the drive motor 1 can be directly transmitted to the bevel gear 34 (change-speed hub 2) which is driven to bring the front wheel 4 into rotation. When the auxiliary power of the drive motor 1 is not required, the drive motor 1 can be switched off to ascend the drive motor 1 (while the axle 41 descends along the elongated hole 121). At this time, the bevel gear 132 of the power output shaft 13 is not meshed with the bevel gear 34. Therefore, the output power of the drive motor 1 can't be transmitted to the bevel gear 34 coupled with the change-speed hub 2. Accordingly, the front wheel 4 naturally runs with other external force.

The weight of the above-mentioned drive motor 1 and related units are distributed to the front wheel 4. Thus, the configuration of the axle of the back wheel can be effectively simplified. This results in an easy assembly and repair. Moreover, the front and rear wheels are evenly loaded, thereby effectively reducing the overload of the rear wheel. Accordingly, the riding control can be improved.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A drive mechanism of an electrical bike at least comprising:
a drive motor connected to one side of front fork of a bike and vertically movable within a proper range, a transmission gear set of said drive motor being used such that the power output shaft and the central axis of the drive motor vertically extend, a drive gear being positioned at end of said power output shaft;
a hub disposed at outer side of axle of front wheel and synchronically movable with said front wheel;
a transmission unit arranged at one side of said hub and synchronically movable with said hub, inside of said transmission unit having bulged teeth corresponding to said drive gear at the end of said power output shaft;
wherein the connection between said drive gear of said power output shaft and said transmission unit is adjustable by means that said drive motor is vertically moved, and wherein said hub and said front wheel are driven by said power output shaft through said coupled transmission unit, thereby achieving the effect of an auxiliary or a full drive.

2. The drive mechanism of an electrical bike as claimed in claim 1, wherein said transmission unit is constructed as an annular gear.

3. The drive mechanism of an electrical bike as claimed in claim 1, wherein said transmission unit is constructed as a gear.

4. The drive mechanism of an electrical bike as claimed in claim 1, wherein said hub is connected with a change-speed mechanism which is controllable by a pull rope to change the ratio of gear within said change-speed hub so that the speed of bike and the torsion can be adjustable as required.
